(19) United States
(12) Patent Application Publication
(10) Pub. No.: US 2003/0047474 A1
(43) Pub. Date: Mar. 13, 2003

(54) Fresh cut flower shipping/display container

(76) Inventor: David Dahlson, Woodland Hills, CA (US)

Correspondence Address: ARTHUR FREILICH, 9045 CORBIN AVE, #260, NORTHRIDGE, CA, 91324-3343, US

(21) Appl. No.: 09/952,810

(22) Filed: Sep. 11, 2001

(51) Int. Cl. B65D 85/52; A01G 9/02; B65D 85/20

(52) U.S. Cl. 206/423; 47/84; 206/443; 206/806

(57) ABSTRACT

A flower container in accordance with the invention is characterized by a container shell comprised of a head portion, a base portion, and a connecting trunk portion. The trunk portion defines a plurality of parallel elongate channels, each dimensioned to accommodate one or more flower stems. First ends of the channels open into an upper cavity, defined by the head portion, dimensioned to accommodate flower blooms. Second ends of the channels open into a lower cavity defined by the shell base portion. The lower cavity is useful for accommodating an aqueous gel intended to contact the stem lower ends to nourish the flowers.

### FIELD OF THE INVENTION

This invention relates generally to flower packaging and more particularly to a container suitable for shipping and/or displaying fresh cut flowers.

### BACKGROUND OF THE INVENTION

Fresh cut flowers are distributed to consumers through multiple channels to satisfy growing demand. These channels include mass market environments, e.g., supermarkets, as well as direct shipment to consumer residences as a result of on-line and telephone shopping.

The packaging of flowers for shipment presents unique challenges because the flowers can be easily damaged, e.g., they can be physically crushed or bruised, or deprived of sufficient moisture and air to maintain their freshness. Regardless of the cause, such damage generally renders the flowers worthless.

### SUMMARY OF THE INVENTION

The present invention is directed to a container particularly configured to accommodate fresh cut flowers for shipment and/or display.

A flower container in accordance with the invention is characterized by a container shell comprised of a head portion, a base portion, and a connecting trunk portion. The trunk portion defines a plurality of parallel elongate channels, each dimensioned to accommodate one or more flower stems. First ends of the channels open into an upper cavity, defined by the head portion, dimensioned to accommodate flower blooms. Second ends of the channels open into a lower cavity defined by the shell base portion. The lower cavity is useful for accommodating an aqueous gel intended to contact the stem lower ends to nourish the flowers.

In accordance with a preferred embodiment, the container shell is comprised of first and second shell members which are preferably hinged to one another. With the shell members open, the aforementioned cavities and channels are accessible allowing fresh cut flowers to be laid therein. The channels are dimensioned to accommodate variously sized stems. Spacers, e.g., cardboard or foam pieces, are placed in the channels, when necessary, to snugly hold the stems and prevent movement relative to the container. The flower blooms are preferably accommodated in the upper cavity so as to avoid contact with the cavity wall. With the shell members closed, the flowers are protected from damage by the structure of the shell. The shell members are preferably fabricated of plastic formed to define a thin semi-rigid wall. The wall is preferably at least in part transparent so that the flowers are visible through the container. The aforementioned aqueous gel is preferably housed in small capsules, each having a cap apertured to snugly receive a stem lower end. The capsules are preferably dimensioned to be snugly received in the lower cavity and/or channels to help prevent relative movement between the flowers and container wall.

For shipment, the flower container is preferably placed in a cardboard sleeve to enhance rigidity. A preferred sleeve includes a window so that the flowers are visible through the container and sleeve. Alternatively, the two shell members can be secured together for shipment by a flexible band adhered around the respective trunk portions and/or by fastening the edges of opposed shell members, as by stapling. It is not intended that the edges be hermetically sealed. Rather, it is preferable to allow air movement into and out of the container to permit the flowers to absorb air and moisture naturally.

### BRIEF DESCRIPTION OF THE DRAWING

FIG. 1 is an isometric view of a preferred flower container comprised of first and second hinged shell members shown in open position and accommodating flowers shown in phantom;

FIG. 2 is an isometric view of the container of FIG. 1 in closed position;

FIG. 3 is an isometric view of the container of FIG. 2 being inserted into a protective cardboard sleeve; and

FIG. 4 is an isometric view of the container of FIG. 2 having a band wrapped around the trunk portions of the two shell members.

### DETAILED DESCRIPTION

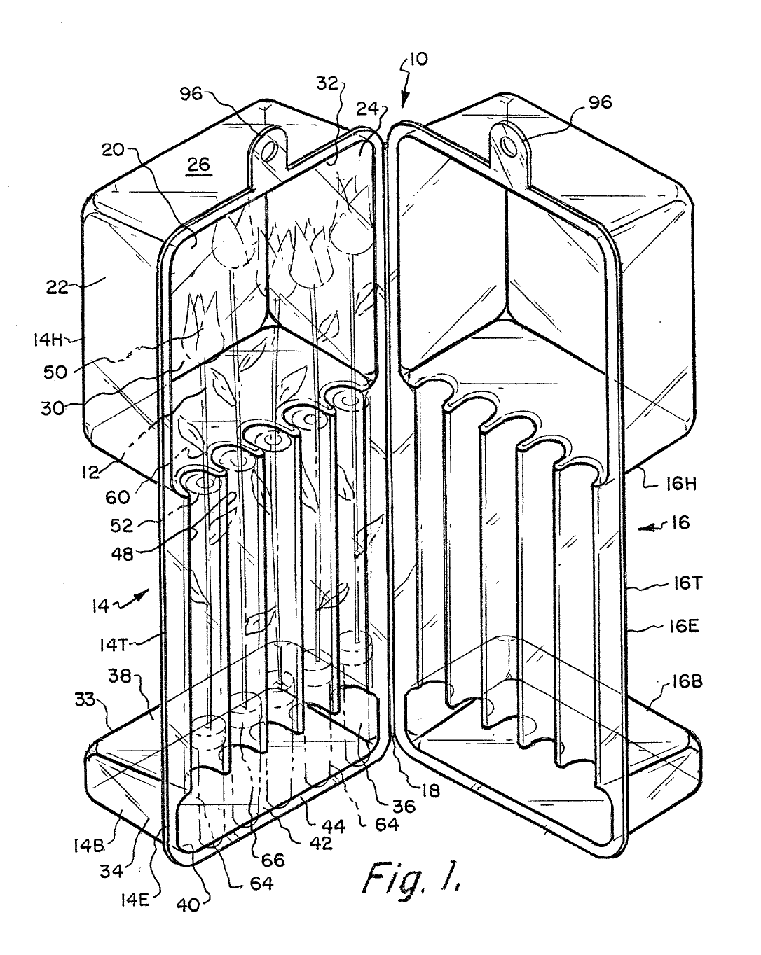

Attention is now directed to FIG. 1 which depicts a preferred embodiment of a container 10 in accordance with the present invention. The container 10 is configured to accommodate fresh cut flowers, shown in phantom at 12, for shipment and/or display.

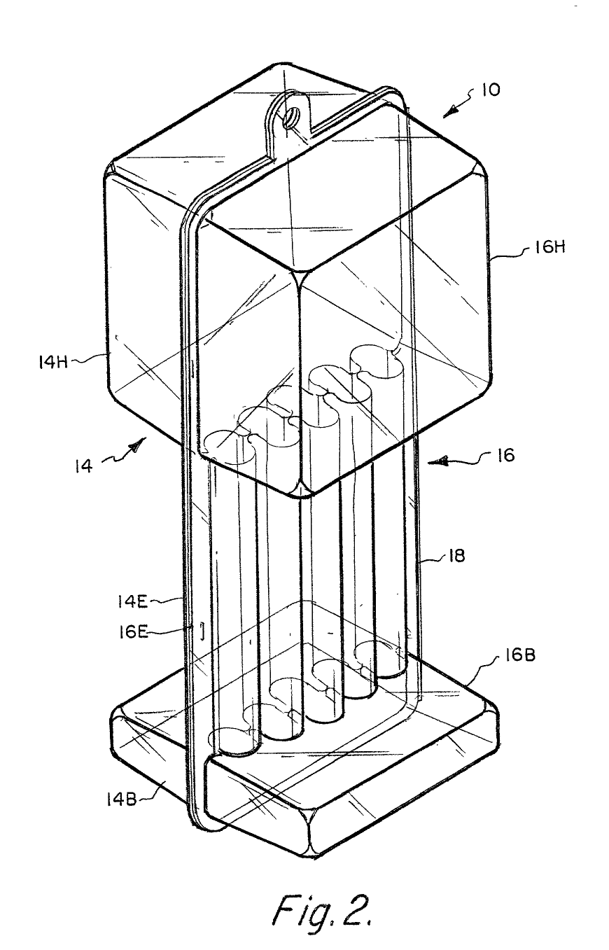

The container 10 is preferably comprised of a first shell member 14 and a second shell member 16 hinged together at 18 for movement between an open position (FIG. 1) and a closed position (FIG. 2). The shell members 14 and 16, and connecting hinge 18, are preferably integrally formed of plastic in a common molding operation.

Each of the shell members 14 and 16 is formed of a thin semi-rigid wall configured to include a head portion 14H, 16H, a base portion 14B, 16B and a trunk portion 14T, 16T which connects the head and base portions. The shell members 14, 16 respectively define peripheral edges 14E, 16E intended to abut one another when the shell members are pivoted to the closed state depicted in FIG. 2. Inasmuch as the shell members 14 and 16 are preferably identically shaped, the explanation hereinafter will, for simplicity, primarily refer only to shell member 14.

Note that the shell member head portion 14H defines a rear wall 20, opposed side walls 22, 24 and upper and lower walls 26, 28. The walls 20, 22, 24, 26, and 28 define an upper cavity 30 whose front face 32, opposite rear wall 20 is open. The base portion 14B also includes a rear wall 33, opposed side walls 34, 36 and top and bottom walls 38 and 40. The walls of base portion 14B define a lower cavity 42 whose front face 44, opposite rear wall 33, is open.

The trunk portion 14T connects the head portion 14H to the base portion 14B. More particularly, the trunk portion defines a plurality of parallel elongate channels 48. The channels 48 open at their top end into the upper cavity 30 and at their bottom end into the lower cavity 42.

The container 10 depicted in FIGS. 1 and 2 is intended for use to ship fresh cut flowers, depicted at 12. The flowers are comprised of stems 60 which are intended to be snugly accommodated within the channels 48. The stems carry flower blooms 50 at their upper ends which are intended to be accommodated in upper cavity 30.

The channels 48 are preferably variously sized to accommodate various stem sizes. Regardless, it is preferable to also employ spacers, e.g., packing material or apertured cardboard discs 52 around the stems to hold them snugly in the channels 48. It is also contemplated that multiple capsules 64 containing aqueous gel be provided. More particularly, the aqueous gel capsules can be provided with caps 66 which are apertured to snugly receive the lower ends of stems 60 which extend into the gel to provide nourishment for the flower blooms. The capsules are preferably dimensioned to fit snugly in the channels 48 and/or lower cavity 42 of the base portion 14B. The purpose of the spacers and properly dimensioned gel capsules is to snugly retain the flower blooms and stems within shell member 14 and to prevent their movement relative to the shell wall.

As previously mentioned, the shell members 14 and 16 are preferably identically formed. When the shell members are in their open position depicted in FIG. 1, the upper and lower cavities and channels are open and accessible to enable flowers to be laid in the container or removed from the container. For purposes of shipment, the shell members 14 are pivoted to the closed position (FIG. 2) around hinge 18 to juxtapose the open front faces of the respective shell members 14 and 16 and thus close the respective upper and lower cavities and channels as shown in FIG. 2.

The wall of the shell members is selected to be transparent, at least in part, in order that the flower blooms are visible through the wall. When the shell members 14, 16 are in their closed position as shown in FIG. 2, the confronting shell member edges 14E, 16E are preferably secured together by some type of fastener, such as a staple. It is not intended that the edges 14E, 16E be hermetically sealed. Rather, it is desired that they merely be fastened together to enable air to move into and out of the container past the edges to allow the flowers to absorb air and moisture naturally.

Attention is now directed to FIG. 3 which illustrates the closed container of FIG. 2 being inserted into a cardboard sleeve 80. It is preferred that the container 10 be shipped in a cardboard sleeve 80 in order to enhance the rigidity of the container structure thin plastic wall. The cardboard sleeve 80 is preferably provided with one or more windows 82 which align with the transparent portion of the shell member wall for the purpose of displaying the flower blooms through the container 10 and sleeve 80.

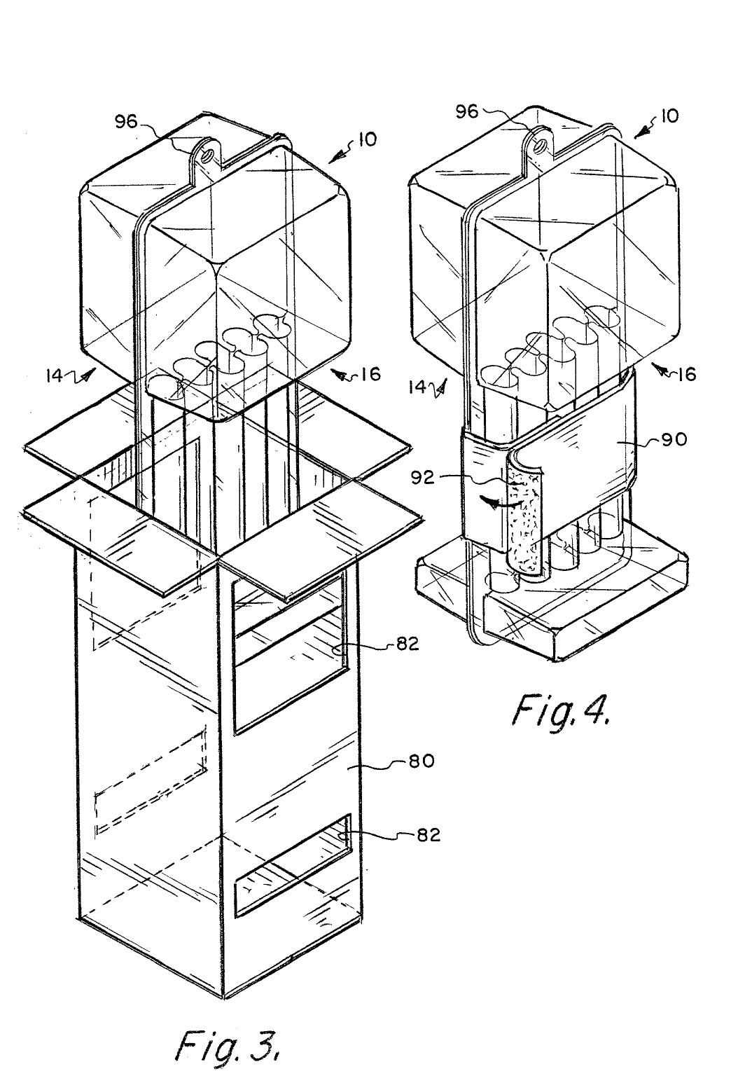

An alternative scheme for packaging the container 10 is shown in FIG. 4 wherein a flexible band 90 is fitted around the trunk portions of the shell members 14 and 16. The band 90 can be provided with adhesive 92 on one face to facilitate the sealing around the trunk portions. Regardless of whether the container is placed in a cardboard sleeve as depicted in FIG. 3 or wrapped by a flexible band 90 as depicted in FIG. 4, It is preferable that the confronting edges of the shell members 14, 16, be fastened, as by staples, as previously mentioned.

The container 10 can be readily displayed in a retail environment by standing substantially upright on its bottom wall 40 or by being suspended via an apertured tab 96 projecting upwardly.

From the foregoing it should now be appreciated that a shipping/display container has been disclosed herein for storing fresh cut flowers while attractively displaying and protecting the flowers from damage. Although a single specific embodiment has been disclosed, it should be recognized that variations and modifications of the invention will readily occur to those skilled in the art without departing from the spirit and scope of the present invention. It is accordingly intended that the appended claims be interpreted to encompass such variations and modifications.

1. A container for accommodating fresh cut flowers, said container comprising:
a shell including:
(1) a head portion enclosing an upper cavity;
(2) a base portion enclosing a lower cavity; and
(3) a trunk portion defining a plurality of parallel elongate channels for accommodating stems which project into said head portion to situate flowers carried by said stems in said upper cavity.

2. The container of claim 1 wherein at least part of said shell head portion is transparent.

3. The container of claim 1 wherein said shell is formed of first and second opposed shell members.

4. The container of claim 3 wherein said first and second shell members are hinged together for pivotal movement between open and closed positions.

5. The container of claim 4 including a sleeve configured to fit snugly around said first and second shell members, said sleeve defining a window aligned with said head portion transparent part.

6. The container of claim 4 including a band configured to fit snugly around said shell trunk portion.

7. A container for shipping and/or displaying fresh cut flowers, said container comprising:
a first shell member configured to form an upper cavity and a lower cavity and having a plurality of elongate parallel channels extending between said cavities; and
a second shell member configured for mounting relative to said first shell member for movement between an open position and a closed position, said open position offering access enabling stems to be placed in said channels and flower blooms to be placed in said upper cavity, said closed position substantially sealing said channels and cavities to protect the contents therein.

8. The container of claim 7 wherein said first and second shell members are substantially identically formed and mounted in opposed relationship.

9. The container of claim 8 wherein said shell members are formed integrally and are hinged to one another.

10. The container of claim 8 wherein each of said shell members is comprised of a thin semi-rigid wall.

11. The container of claim 10 wherein at least one of said shell members includes a transparent wall portion for viewing flower blooms in said upper cavity.

12. The container of claim 7 further including aqueous gel in said lower cavity for contacting stems in said recesses.

13. The container of claim 7 wherein said plurality of elongate channels have differently dimensioned cross-sections for snugly accommodating different size stems.

14. The container of claim 7 including a sleeve configured to fit snugly around said first and second shell members to protect said shell members during shipping.

15. The container of claim 14 wherein at least one of said shell members includes a transparent wall portion; and wherein
said sleeve includes a window aligned with a transparent portion of said shell members.

16. The container of claim 7 further including a band configured to fit snugly around said shell members to retain them in said closed position.
